(19) United States
(12) Patent Application Publication
(10) Pub. No.: US 2019/0086992 A1
(43) Pub. Date: Mar. 21, 2019

(54) DYNAMIC POWER RAILS FOR ELECTRONIC DISPLAY

(71) Applicant: Apple Inc., Cupertino, CA (US)

(72) Inventors: Hung Sheng Lin, San Jose, CA (US); Hyunwoo Nho, Stanford, CA (US); Hyunsoo Kim, Stanford, CA (US); Shengkui Gao, San Jose, CA (US); Chun Lu, San Jose, CA (US); Sinan Alousi, Campbell, CA (US); Chin-Wei Lin, San Jose, CA (US); Jesse Aaron Richmond, San Francisco, CA (US); Yafei Bi, Los Altos Hills, CA (US); Injae Hwang, Minato-ku (JP); Haifeng Li, Campbell, CA (US); Mohammad Hajirostam, San Jose, CA (US)

(21) Appl. No.: 16/028,199

(22) Filed: Jul. 5, 2018

Related U.S. Application Data
(60) Provisional application No. 62/561,134, filed on Sep. 20, 2017.

(51) Int. Cl. G06F 1/32; G09G 3/3258

(52) U.S. Cl. CPC G06F 1/3265; G09G 3/3258; G09G 2320/0626; G09G 2310/0264; G09G 2320/0233; G09G 2330/021

(57) ABSTRACT

An electronic display includes an active area having an array of pixels. The electronic display also includes multiple data power rails coupled to the active area that supply power to the array of pixels. The electronic display further includes data driving circuitry coupled to the multiple data power rails that drive the array of pixels. The electronic display also includes a controller coupled to the data driving circuitry having a processor. The processor causes the array of pixels to emit light based on a display brightness value. The processor also causes a pixel of the array of pixels to emit light at a brightness of gray level 0 by dynamically adjusting a data power rail of the multiple data power rails.

### CROSS-REFERENCE TO RELATED APPLICATION

This application claims priority to U.S. Provisional Patent Application No. 62/561,134, filed Sep. 20, 2017, entitled “Dynamic Power Rails for Electronic Display,” the contents of which is incorporated by reference in its entirety for all purposes.

### BACKGROUND

The present disclosure relates generally to electronic displays and, more particularly, to dynamically supplying power to the electronic displays.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Flat panel displays, such as active matrix organic light emitting diode (AMOLED) displays, micro-LED (μLED) displays, and the like, are commonly used in a wide variety of electronic devices, including such consumer electronics as televisions, computers, and handheld devices like cellular telephones, audio and video players, gaming systems, and so forth. The flat panel displays may provide a flat display in a relatively thin package that is suitable for use in a variety of electronic goods. In addition, such devices may use less power than comparable display technologies, making them suitable for use in battery-powered devices or in other contexts where it is desirable to minimize power usage.

Electronic displays may include picture elements, referred to as pixels, arranged in a matrix to display an image when the pixels are programmed. Many different types of voltage signals may be involved in programming the pixels, such as emission supply voltages, a panel initialization voltage, analog (e.g., data) voltages, logic supply voltages, and the like. In many cases, using relatively higher voltage signals (e.g., higher supply voltages) may lead to more reliability in the electronic display but also may lead to increased power consumption, which could result in a reduced battery life for the electronic device.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relates to dynamically supplying power to certain electronic display devices including, for example, light emitting diode (LED) displays, such as organic light emitting diode (OLED) displays, active matrix organic light emitting diode (AMOLED) displays, micro LED (μLED) displays, liquid crystal display displays, and the like. To display an image, picture elements or pixels of a display may be programmed to display an image using different types of voltage signals, such as emission supply voltages, a panel initialization voltage, analog (e.g., data) voltages, logic supply voltages, and the like. The voltages applied to the pixel may be regulated by, for example, thin film transistors (TFTs). For example, a circuit switching TFT may be used to regulate current flowing into a storage capacitor, and a driver TFT may be used to regulate the voltage being provided to a light emitting device (e.g., an LED) of an individual pixel.

Each pixel of the electronic display may emit light of a certain brightness, as measured by a gray level (“G”), based on the voltages applied. For example, the minimum gray level (such that the pixel emits “black”) is G₀, while the maximum gray level G_{N}, for an 8-bit-deep image, is G₂₅₅. Greater data voltage may be applied to realize lower gray levels. As such, the data voltage for G₀ (V₀) may be supplied directly (e.g., without modification and independent of a display brightness value) from a voltage regulator or power supply to receive maximum data voltage. The remaining gray levels, G₁-G_{N}, may be dependent on the display brightness value, such that, when the electronic display is set or adjusted to operate at a lower display brightness value, the data voltages for G₁-G_{N} (V₁-V_{N}, respectively) may be decreased. However, V₀ may still receive maximum data voltage. In some cases, this may be wasteful and inefficient, as V₀ may be decreased while the pixel still accurately displays G₀. Moreover, the larger voltage gap between V₀ and V₁ may cause hysteresis stress on a driver TFT associated with the pixel, leading to shorter lifespan of the pixel or image artifacts on the display. Finally, the growing reliance on electronic devices having LED (or similar) displays has generated interest in improvement of the operation of the displays.

Dynamically adjusting a power rail providing the data voltage (V₀) to generate brightness of a gray level of G₀ at a pixel, such that the power rail does not provide a maximum data voltage, may enable power savings while still accurately displaying G₀. Moreover, a voltage gap between V₀ (used to generate G₀) and V₁ (used to generate G₁) may be decreased, resulting in decreasing hysteresis stress on a driver TFT associated with the pixel. Dynamically adjusting the power rail providing the data voltage (V₀) may enable decreasing voltages (e.g., emission voltages, a panel initialization voltage, logic supply voltages, and the like) provided on other power rails, further decreasing power used by the display.

Various refinements of the features noted above may be made in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device that performs display sensing and compensation, in accordance with an embodiment;

FIG. 2 is a perspective view of a notebook computer representing an embodiment of the electronic device of FIG. 1;

FIG. 3 is a front view of a hand-held device representing another embodiment of the electronic device of FIG. 1;

FIG. 4 is a front view of another hand-held device representing another embodiment of the electronic device of FIG. 1;

FIG. 5 is a front view of a desktop computer representing another embodiment of the electronic device of FIG. 1;

FIG. 6 is a front view and side view of a wearable electronic device representing another embodiment of the electronic device of FIG. 1;

FIG. 7 is a block diagram of a system for dynamically adjusting power rails of a display of the electronic device of FIG. 1, according to an embodiment of the present disclosure;

FIG. 8 is a graph of a relationship between data voltage and pixel luminance for different display brightness values of the display of FIG. 7, according to an embodiment of the present disclosure;

FIG. 9 is a schematic diagram of a system for dynamically adjusting a data power rail of the display of FIG. 7, according to an embodiment of the present disclosure;

FIG. 10 is a flow diagram of a method for dynamically adjusting a data power rail of the display of FIG. 7, according to an embodiment of the present disclosure;

FIG. 11 is a graph of gray levels and data voltages associated with a lower display brightness value when dynamically adjusting a data power rail of the display of FIG. 7, according to an embodiment of the present disclosure; and

FIG. 12 is a schematic diagram of a pixel of the display of FIG. 7 that enables dynamically adjusting power rails, according to an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Each pixel of an electronic display may emit light of a certain brightness, as measured by a gray level (“G”), based on the voltages applied. For example, the minimum gray level (such that the pixel emits “black”) is G₀, while the maximum gray level G_{N}, for an 8-bit-deep image, is G₂₅₅. The present disclosure refers to a gray level of X as G_{X}, such that a gray level of 0 is referred to as G₀, a gray level of 255 is referred to as G₂₅₅, and so on. Lower data voltages may be applied to realize higher gray levels (e.g., G₂₅₅), while higher data voltages may be applied to realize lower gray levels (e.g., G₀). Rather than supplying the data voltage for G₀ (V₀) at a fixed voltage (e.g., a maximum data voltage that may be provided by a voltage regulator or power supply), the data voltage for G₀ (V₀) may be dynamically adjusted. For example, the data voltage for G₀ (V₀) may be adjusted based on one or more operational parameters of the display, such as a display brightness value, refresh rate, emission duration, display temperature, age of the display, and the like. The remaining gray levels, G₁-G_{N}, may adjusted dynamically as well, based on the same or different operational parameters of the display.

Dynamically adjusting a power rail that provides the data voltage (V₀) that generates a brightness of a gray level of G₀ at a pixel, such that the power rail does not provide a maximum data voltage, may enable power savings while still accurately displaying G₀. Moreover, a voltage gap between V₀ (used to generate G₀) and V₁ (used to generate G₁) may be decreased, resulting in decreasing hysteresis stress on a driver TFT associated with the pixel. Dynamically adjusting the power rail providing the data voltage (V₀) may enable decreasing voltages (e.g., emission voltages, a panel initialization voltage, logic supply voltages, and the like) provided on other power rails, further decreasing power used by the display.

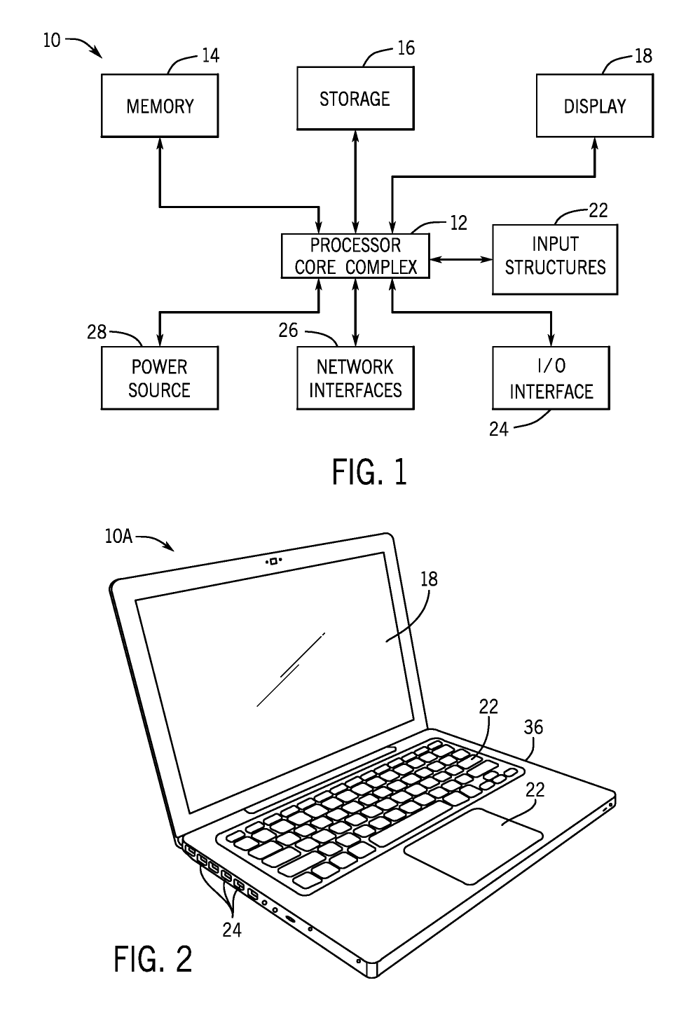

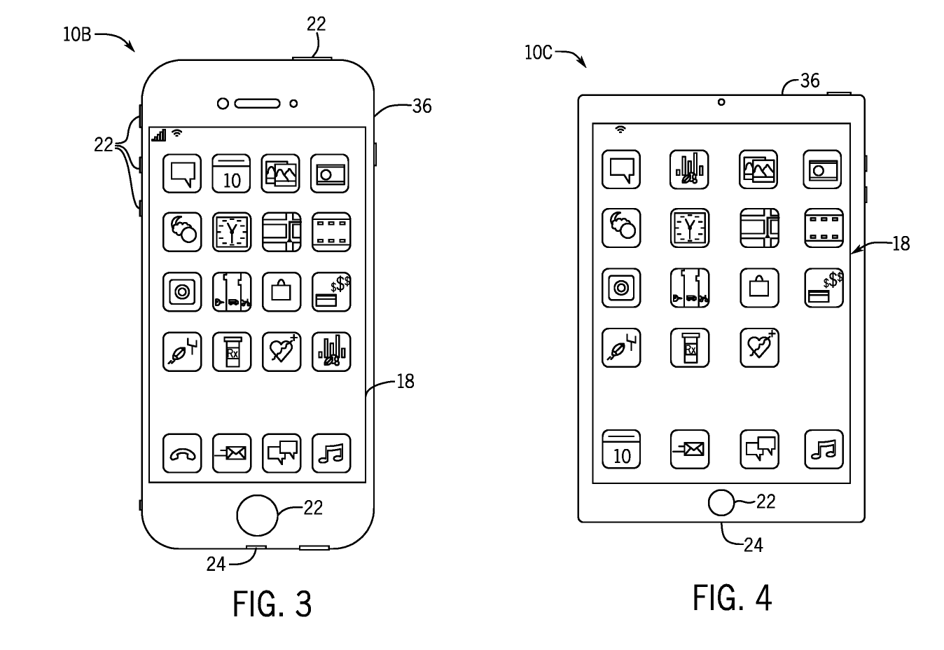

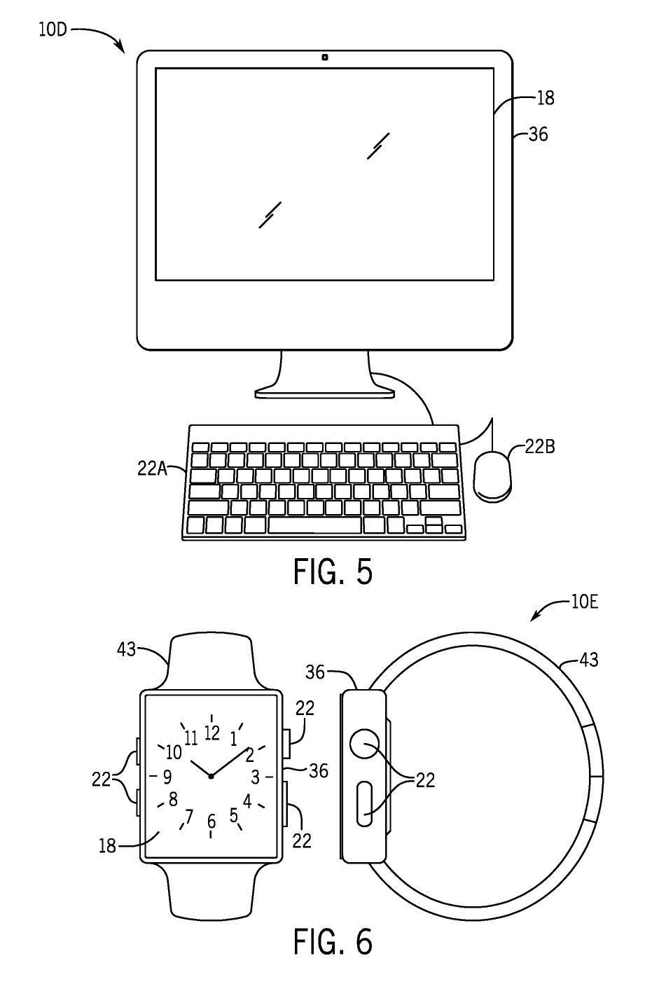

With this in mind, a block diagram of an electronic device 10 is shown in FIG. 1. As will be described in more detail below, the electronic device 10 may represent any suitable electronic device, such as a computer, a mobile phone, a portable media device, a tablet, a television, a virtual-reality headset, a vehicle dashboard, or the like. The electronic device 10 may represent, for example, a notebook computer 10A as depicted in FIG. 2, a handheld device 10B as depicted in FIG. 3, a handheld device 10C as depicted in FIG. 4, a desktop computer 10D as depicted in FIG. 5, a wearable electronic device 10E as depicted in FIG. 6, or a similar device.

The electronic device 10 shown in FIG. 1 may include, for example, a processor core complex 12, a local memory 14, a main memory storage device 16, an electronic display 18, input structures 22, an input/output (I/O) interface 24, a network interface 26, and a power source 28. The various functional blocks shown in FIG. 1 may include hardware elements (including circuitry), software elements (including machine-executable instructions stored on a tangible, non-transitory medium, such as the local memory 14 or the main memory storage device 16) or a combination of both hardware and software elements. It should be noted that FIG. 1 is merely one example of a particular implementation and is intended to illustrate the types of components that may be present in electronic device 10. Indeed, the various depicted components may be combined into fewer components or separated into additional components. For example, the local memory 14 and the main memory storage device 16 may be included in a single component.

The processor core complex 12 may carry out a variety of operations of the electronic device 10. The processor core complex 12 may include any suitable data processing circuitry to perform these operations, such as one or more microprocessors, one or more application specific processors (ASICs), or one or more programmable logic devices (PLDs). In some cases, the processor core complex 12 may execute programs or instructions (e.g., an operating system or application program) stored on a suitable article of manufacture, such as the local memory 14 and/or the main memory storage device 16. In addition to instructions for the processor core complex 12, the local memory 14 and/or the main memory storage device 16 may also store data to be processed by the processor core complex 12. By way of example, the local memory 14 may include random access memory (RAM) and the main memory storage device 16 may include read only memory (ROM), rewritable non-volatile memory such as flash memory, hard drives, optical discs, or the like.

The electronic display 18 may display image frames, such as a graphical user interface (GUI) for an operating system or an application interface, still images, or video content. The processor core complex 12 may supply at least some of the image frames. The electronic display 18 may be a self-emissive display, such as an organic light emitting diodes (OLED) display, a micro-LED display, a micro-OLED type display, or a liquid crystal display (LCD) illuminated by a backlight. In some embodiments, the electronic display 18 may include a touch screen, which may allow users to interact with a user interface of the electronic device 10. The electronic display 18 may employ display panel sensing to identify operational variations of the electronic display 18. This may allow the processor core complex 12 to adjust image data that is sent to the electronic display 18 to compensate for these variations, thereby improving the quality of the image frames appearing on the electronic display 18.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. The network interface 26 may include, for example, interfaces for a personal area network (PAN), such as a Bluetooth network, for a local area network (LAN) or wireless local area network (WLAN), such as an 802.11x Wi-Fi network, and/or for a wide area network (WAN), such as a cellular network. The network interface 26 may also include interfaces for, for example, broadband fixed wireless access networks (WiMAX), mobile broadband Wireless networks (mobile WiMAX), asynchronous digital subscriber lines (e.g., ADSL, VDSL), digital video broadcasting-terrestrial (DVB-T) and its extension DVB Handheld (DVB-H), ultra wideband (UWB), alternating current (AC) power lines, and so forth. The power source 28 may include any suitable source of power, such as a rechargeable lithium polymer (Li-poly) battery and/or an alternating current (AC) power converter.

In certain embodiments, the electronic device 10 may take the form of a computer, a portable electronic device, a wearable electronic device, or other type of electronic device. Such computers may include computers that are generally portable (such as laptop, notebook, and tablet computers) as well as computers that are generally used in one place (such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a notebook computer 10A, is illustrated in FIG. 2 in accordance with one embodiment of the present disclosure. The depicted computer 10A may include a housing or enclosure 36, an electronic display 18, input structures 22, and ports of an I/O interface 24. In one embodiment, the input structures 22 (such as a keyboard and/or touchpad) may be used to interact with the computer 10A, such as to start, control, or operate a GUI or applications running on computer 10A. For example, a keyboard and/or touchpad may allow a user to navigate a user interface or application interface displayed on the electronic display 18.

FIG. 3 depicts a front view of a handheld device 10B, which represents one embodiment of the electronic device 10. The handheld device 10B may represent, for example, a portable phone, a media player, a personal data organizer, a handheld game platform, or any combination of such devices. By way of example, the handheld device 10B may be a model of an iPod® or iPhone® available from Apple Inc. of Cupertino, Calif. The handheld device 10B may include an enclosure 36 to protect interior components from physical damage and to shield them from electromagnetic interference. The enclosure 36 may surround the electronic display 18. The I/O interfaces 24 may open through the enclosure 36 and may include, for example, an I/O port for a hard-wired connection for charging and/or content manipulation using a standard connector and protocol, such as the Lightning connector provided by Apple Inc., a universal service bus (USB), or other similar connector and protocol.

User input structures 22, in combination with the electronic display 18, may allow a user to control the handheld device 10B. For example, the input structures 22 may activate or deactivate the handheld device 10B, navigate user interface to a home screen, a user-configurable application screen, and/or activate a voice-recognition feature of the handheld device 10B. Other input structures 22 may provide volume control, or may toggle between vibrate and ring modes. The input structures 22 may also include a microphone may obtain a user's voice for various voice-related features, and a speaker may enable audio playback and/or certain phone capabilities. The input structures 22 may also include a headphone input may provide a connection to external speakers and/or headphones.

FIG. 4 depicts a front view of another handheld device 10C, which represents another embodiment of the electronic device 10. The handheld device 10C may represent, for example, a tablet computer or portable computing device. By way of example, the handheld device 10C may be a tablet-sized embodiment of the electronic device 10, which may be, for example, a model of an iPad® available from Apple Inc. of Cupertino, Calif.

Turning to FIG. 5, a computer 10D may represent another embodiment of the electronic device 10 of FIG. 1. The computer 10D may be any computer, such as a desktop computer, a server, or a notebook computer, but may also be a standalone media player or video gaming machine. By way of example, the computer 10D may be an iMac®, a MacBook®, or other similar device by Apple Inc. It should be noted that the computer 10D may also represent a personal computer (PC) by another manufacturer. A similar enclosure 36 may be provided to protect and enclose internal components of the computer 10D such as the electronic display 18. In certain embodiments, a user of the computer 10D may interact with the computer 10D using various peripheral input devices, such as input structures 22A or 22B (e.g., keyboard and mouse), which may connect to the computer 10D.

Similarly, FIG. 6 depicts a wearable electronic device 10E representing another embodiment of the electronic device 10 of FIG. 1 that may be configured to operate using the techniques described herein. By way of example, the wearable electronic device 10E, which may include a wristband 43, may be an Apple Watch® by Apple, Inc. However, in other embodiments, the wearable electronic device 10E may include any wearable electronic device such as, for example, a wearable exercise monitoring device (e.g., pedometer, accelerometer, heart rate monitor), or other device by another manufacturer. The electronic display 18 of the wearable electronic device 10E may include a touch screen display 18 (e.g., LCD, OLED display, active-matrix organic light emitting diode (AMOLED) display, and so forth), as well as input structures 22, which may allow users to interact with a user interface of the wearable electronic device 10E.

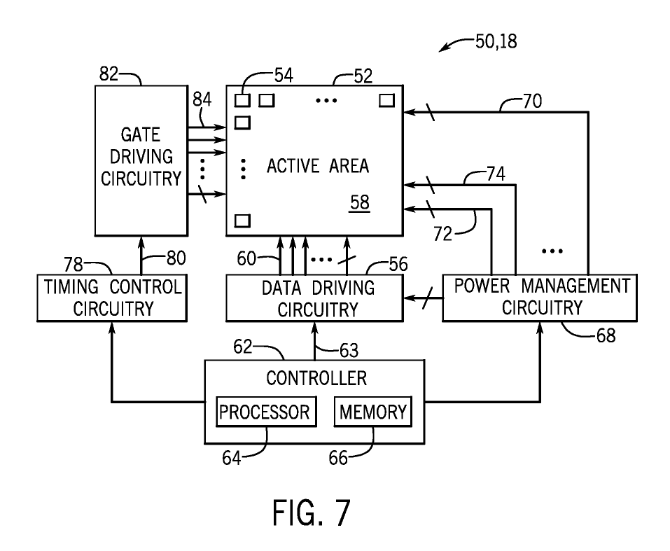

FIG. 7 is a block diagram of a system 50 for dynamically adjusting power rails of a display 18 of the electronic device 10 of FIG. 1, according to an embodiment of the present disclosure. The system 50 may include an active area 52 that has an array of pixels 54. The active area 52 may be coupled to data driving circuitry 56 that drives circuitry 58 in the active area 52 via data or analog power rails 60. The active area circuitry 58 may be used for displaying images via the pixels 54.

The data driving circuitry 56 may be coupled to a controller 62, which may control operation of and send image data 63 to the data driving circuitry 56. The controller 62 may include a controller processor or processing circuitry 64 and controller memory 66. The controller processor 64 may execute instructions stored in the controller memory 66. In some embodiments, the controller processor 64 may be included in the processor core complex 12, and/or the controller memory 66 may be included in the local memory 14, the main memory storage device 16, a separate tangible, non-transitory, computer-readable medium, or any combination thereof.

The controller 62 may also be coupled to and control operation of power management circuitry 68. The power management circuitry 68 may manage and supply power provided to the active area 52 via power rails 70. For example, the power rails 70 may include one or more emission power rails 72 that provide power to the active area to emit light. The power rails 70 may also include one or more panel initialization power rails 74 that provide power to initialize the active area 52. The power management circuitry 68 may further provide power to the data driving circuitry 56 to send along the data power rails 60. In some embodiments, the data power rails 60 may instead be located between the power management circuitry 68 and the active area 52.

The controller 62 may further be coupled to timing control circuitry 78, which may determine and transmit timing data 80 to gate driving circuitry 82 based on the image data 63. Based at least in part on the timing data 80, the gate driving circuitry 82 may transmit gate activation signals to activate one or more rows of pixels 54 via logic supply power rails 84. In some embodiments, the logic supply power rails 84 may be located between the power management circuitry 68 and the active area 52.

Each pixel 54 may emit light of a certain brightness, as measured by a gray level (“G”), based on the voltages applied from the power rails. For example, the minimum gray level (such that the pixel emits “black”) is G₀, while the maximum gray level G_{N}, for an 8-bit-deep image, is G₂₅₅. Lower data voltages may be applied to realize higher gray levels (e.g., G₂₅₅), while higher data voltages may be applied to realize lower gray levels (e.g., G₀). Rather than supplying the data voltage for G₀ (V₀) at a fixed voltage (e.g., a maximum data voltage that may be provided by a voltage regulator or power supply), the data voltage for G₀ (V₀) may be dynamically adjusted. For example, the data voltage for G₀ (V₀) may be adjusted based on one or more operational parameters of the display, such as a display brightness value, refresh rate, emission duration, display temperature, age of the display, and the like. The remaining gray levels, G₁-G_{N}, may adjusted dynamically as well, based on the same or different operational parameters of the display. For example, the remaining gray levels, G₁-G_{N}, may be dependent on the display brightness value, such that, when the display 18 is set or adjusted to operate at a lower display brightness value, the data voltages for G₁-G_{N} (V₁-V_{N}, respectively) may be decreased.

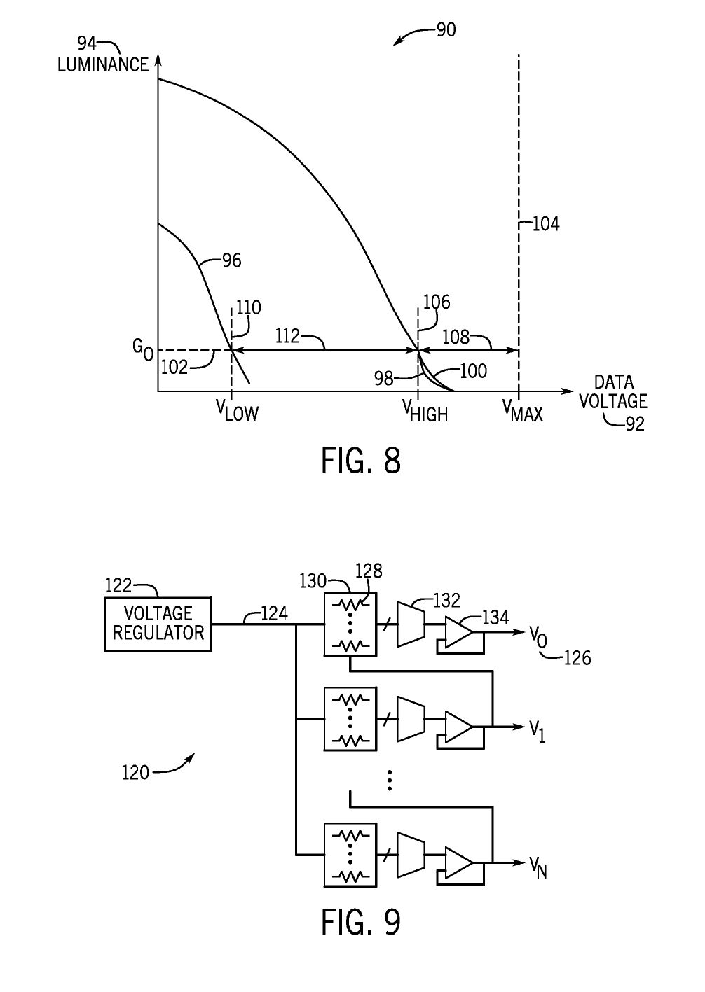

Dynamically adjusting the data power rail 60 providing the data voltage (V₀) that generates a brightness of a gray level of G₀ at a pixel 54, such that the data power rail 60 does not provide a maximum data voltage on the power rail 60, may enable power savings while still accurately displaying G₀. FIG. 8 is a graph 90 of data voltage 92 and pixel luminance 94 for different display brightness values of the display 18 of FIG. 7, according to an embodiment of the present disclosure. A low display brightness curve 96 illustrates a low display brightness value (e.g., of 2 nits). An intermediate display brightness curve 98 illustrates an intermediate display brightness value (e.g., of 100 nits). A high display brightness curve 100 illustrates a high display brightness value (e.g., of 750 nits). It should be understood that a nit is a unit of visible light intensity, which is equivalent to one candela per square meter.

Each of the three display brightness curves 96, 98, 100 show decreasing luminance with increasing data voltage. Luminance G₀ 102 indicates a maximum luminance that is sufficiently black to qualify as the G₀ gray level. Data voltage Vₘₐₓ 104 indicates a maximum data voltage that may be supplied by the data power rail 60. As mentioned above, Vₘₐₓ 104 may be provided by the data power rail 60 to produce the G₀ gray level in a pixel 54. However, as illustrated, a voltage less than Vₘₐₓ 104 may be provided and still produce the G₀ gray level in a pixel 54.

In particular, for high display brightness values (e.g., greater than 2 nits), V_{high} 106 may be provided by the data power rail 60 instead of Vₘₐₓ 104, which may be V_{high margin} 108 volts less than that of Vₘₐₓ 104. As such, for high display brightness values, the voltage provided by the data power rail 60 to generate a brightness of the G₀ gray level at a pixel 54 may be reduced by up to V_{high margin} 108.

For low display brightness values (e.g., less than 2 nits), V_{low} 110 may be provided by the data power rail 60 instead of Vₘₐₓ 104, which may be V_{low margin} 112 volts less than that of Vₘₐₓ 104. As such, for low display brightness values, the voltage provided by the data power rail 60 to generate a brightness of the G₀ gray level at a pixel 54 may be reduced by up to V_{low margin} 112.

FIG. 9 is a schematic diagram of a system 120 for dynamically adjusting the data power rail 60 of the display 18 of FIG. 7, according to an embodiment of the present disclosure. A voltage regulator 122 (e.g., coupled to and/or controlled by the power management circuitry 68) may supply voltage 124 to the pixels 54 of the display 18. To dynamically generate V₀ 126, the voltage 124 may be applied to a variety of resistances composed of one or more resistors 128 of a resistor string 130. A multiplexer 132 may dynamically select a resulting voltage (e.g., based on a selection signal provided from the controller 62) from the one or more resistors 128 of the resistor string 130 to send to an operational amplifier 134, which outputs V₀ 126. The selection signal provided by the controller 62 may be based on the display brightness value. In some embodiments, the selection signal may be additionally or alternatively based on any suitable display operation parameter, including display brightness value, refresh rate, emission duration (e.g., 100% duty cycle or less), display temperature, age of the display, and the like.

As described above, the other G values (e.g., G₁-G_{N}) may already be based on the display brightness value. As such, each corresponding voltage, V₁-V_{N}, may be provided using resistor strings 130, multiplexers 132, and operational amplifiers 134, similar to how V₀ may be provided. In some embodiments, any suitable circuitry and components to generate the G values are contemplated, such as additional resistor strings, multiplexers, operational amplifiers, and the like.

The system 120 may be at least in part disposed in the power management circuitry 68, the data driving circuitry 56, the active area 52, and/or in between any of these components. For example, the system 120 may be disposed on the data power rail 60 of the system 50. In this manner, the data power rail 60 may be dynamically adjusted to provide variable V₀ 126 values, instead of a fixed Vₘₐₓ value 104.

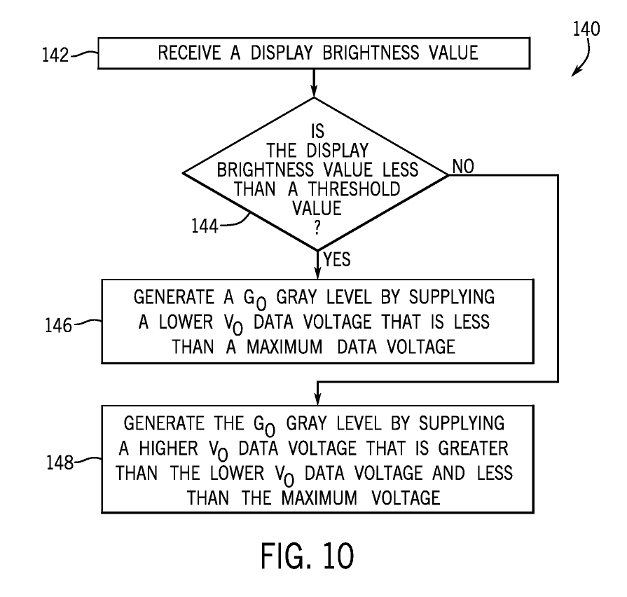

FIG. 10 is a flow diagram of a method 140 for dynamically adjusting the data power rail 60 of the display 18 of FIG. 7, according to an embodiment of the present disclosure. The method 140 may be performed by any suitable device or combination of devices that may compare a display brightness value to a threshold value and dynamically generate a G₀ gray level by supplying a voltage on the data power rail 60. While the method 140 is described using steps in a specific sequence, it should be understood that the present disclosure contemplates that the described steps may be performed in different sequences than the sequence illustrated, and certain described steps may be skipped or not performed altogether. Moreover, while the steps of the method 140 are described below as being performed by the controller 62, it should be understood that the steps of the method 140 may be performed by any suitable device, such as the power management circuitry 68, the data driving circuitry 56, circuitry of the active area 52, the processor core complex 12, or the like.

As illustrated, the controller 62 receives (process block 142) a display brightness value of the display 18. For example, a user may set the display brightness value of the display 18. As another example, the display 18 and/or the controller 62 may automatically select the display brightness value (e.g., via an operating system running on the processor core complex 12 that may determine the display brightness value based on an indication by the user, sensing of ambient conditions such as brightness in a room, and the like).

The controller 62 then determines (decision block 144) whether the display brightness value is less than a threshold value. The threshold value may correspond to a display brightness value that separates the range of all possible display brightness values into multiple sets of display brightness values. In some embodiments, the threshold value may separate the range of display brightness values into multiple sets of display brightness values that enable efficiently reducing power used by the display 18 and/or effectively decreasing the voltage gap between V₀ and V₁, thus decreasing hysteresis stress on a driver TFT associated with the pixel 54. For example, as illustrated in graph 90 of FIG. 8, the low display brightness value (e.g., of 2 nits) illustrated by the low display brightness curve 96 may be the threshold value, if supplying the voltage V_{low} 110 as V₀ efficiently reduces power used by the display 18 and/or effectively decreases the voltage gap between V₀ and V₁. As such, in some embodiments, power saving may be maximized by selecting a threshold value that enables supplying lower V₀ values for the most used or most common display brightness values. In alternative or additional embodiments, decreasing hysteresis stress may be prioritized by selecting a threshold value that enables decreasing the most voltage gaps between V₀ and V₁ for all possible display bright values.

While the method 140 compares the display brightness value with one threshold value, it is contemplated that the display brightness value may be compared to multiple threshold values to provide better fit solutions to save power and/or decrease hysteresis stress.

If the display brightness value is less than the threshold value, then the controller 62 generates (process block 146) the G₀ gray level by supplying a lower V₀ data voltage that is less than a maximum data voltage. In particular, the maximum data voltage may be a maximum fixed voltage supplied the voltage regulator 122 or the power management circuitry 68. In some embodiments, the lower V₀ data voltage may be a minimum voltage that, when supplied to the pixel 54, generates the G₀ gray level for display brightness value equal to the threshold value. For example, as illustrated in the graph 90 of FIG. 8, the lower V₀ data voltage may be V_{low} 110.

Otherwise, if the display brightness value is not less than the threshold value, the controller 62 may generate (process block 148) a G₀ gray level by supplying a higher V₀ data voltage that is greater than the lower V₀ data voltage but still less than the maximum data voltage. In some embodiments, the higher V₀ data voltage may be a minimum voltage that, when supplied to a pixel 54, generates the G₀ gray level for all possible display brightness values of the display 18. For example, as illustrated in the graph 90 of FIG. 8, the higher V₀ data voltage may be V_{high} 106.

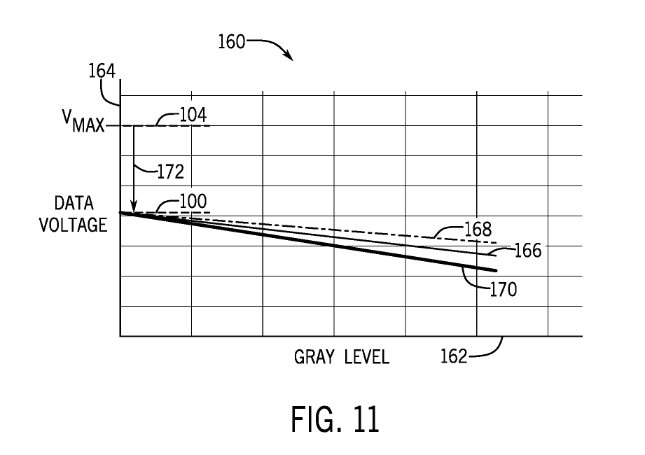

FIG. 11 is a graph 160 of gray levels 162 and data voltages 164 associated with a lower display brightness value when dynamically adjusting the data power rail 60 of the display 18 of FIG. 7, according to an embodiment of the present disclosure. The lower display brightness value may be, for example, 2 nits. The graph 160 may result from using the system 120 of FIG. 9 and/or the method 140 of FIG. 10. The curves 166, 168, 170 represent red, green, and blue colors, respectively, displayed by a pixel 54 of the display 18.

If the data power rail 60 were not dynamically adjusted, and G₀ was generated by supplying a maximum voltage Vₘₐₓ 104 (such that V₀=Vₘₐₓ 104) from the data power rail 60, a large voltage gap 172 might be present between V₀ and V₁. This large voltage gap 172 may cause hysteresis stress on a driver TFT associated with the pixel 54, leading to shorter lifespan of the pixel 54 or image artifacts on the display 18.

However, when the data power rail 60 is dynamically adjusted to reduce V₀ to a lower data voltage value, such as a minimum voltage that may still generate the G₀ gray value for the lower display brightness value, the voltage gap 172 is decreased. As such, the hysteresis stress on the driver TFT associated with the pixel 54 may be decreased, extending the lifespan of the pixel 54 and preventing image artifacts on the display 18.

Moreover, a voltage gap between V₀ (used to generate G₀) and V₁ (used to generate G₁) may be decreased, resulting in decreasing hysteresis stress on a driver TFT associated with the pixel. Dynamically adjusting the power rail providing the data voltage (V₀) may enable decreasing voltages (e.g., emission voltages, a panel initialization voltage, logic supply voltages, and the like) provided on other power rails, further decreasing power used by the display.

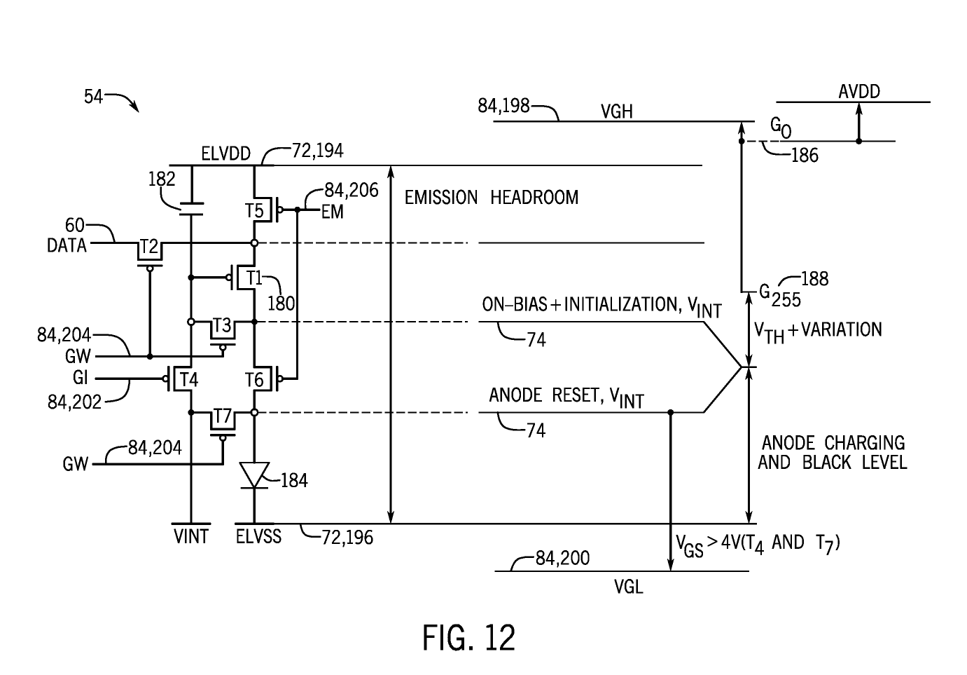

FIG. 12 is a schematic diagram of a pixel 54 of the display 18 of FIG. 7 that enables dynamically adjusting power rails, according to an embodiment of the present disclosure. The pixel 54 may include a number of TFTs 180, a storage capacitor 182, and a light emitting diode (LED) 184, that enable the pixel 54 to emit light via the LED 184 when voltage is supplied to the pixel 54. The pixel 54 may be coupled to data power rails 60, which, for example, provide voltage V₀ to generate a gray level of G₀ 186 and V₂₅₅ to generate a gray level of G₂₅₅ 188.

As discussed above, the controller 62 may dynamically adjust the data power rails 60 based on display brightness value to provide a voltage less than a maximum data voltage that a voltage regulator (e.g., 122) is capable to supply. Moreover, in some embodiments, dynamically adjusting the data power rails 60 may be additionally or alternatively based on any suitable display operation parameter, including display brightness value, refresh rate, emission duration (e.g., 100% duty cycle or less), display temperature, age of the display, and the like.

As illustrated, the pixel 54 is coupled to an AVDD (analog supply voltage) 190 power rail that drives the pixel 54. The pixel 54 may also be coupled to emission power rails 72 that provide power to the pixel 54 to emit light. As illustrated, the emission power rails 72 include an ELVDD (emission drain supply voltage) power rail 194 and an ELVSS (emission source supply voltage) power rail 196. The pixel 54 may further be coupled to panel initialization power rails (V_{INT}) 74 that provide power to initialize the pixel 54.

The pixel 54 may also be coupled to logic supply power rails 84 that supply gate activation signals to activate the pixel 54. As illustrated, the logic supply power rails 84 include a VGH (high gate voltage) power rail 198 and a VGL (low gate voltage) power rail 200. The logic supply power rails also include the GI 202, GW 204, and EM 206 power rails that control switching of the TFTs 180.

To supply the voltage V₀ to generate the gray level of G₀ 186 via the data power rail 60, the high gate voltage and the analog supply voltage may be greater than V₀. If the voltage V₀ were fixed (e.g., at a maximum voltage capable of being provided by the voltage regulator 122), then the high gate voltage and the analog supply voltage may be greater than that fixed voltage. However, dynamically adjusting the voltage V₀ based on the display brightness value enables decreasing the voltage V₀ (e.g., below the maximum voltage capable of being provided by the voltage regulator 122). As such, the voltages provided on other rails 70 to the pixel 54, such as the VGH power rail 198 and/or the AVDD power rail 190, may also be decreased.

Greater power savings may be realized in lower display brightness value applications than higher display brightness value applications because of the larger voltage gap 172 between V₀ and V₁. This may be due to short pulse width of the pulse width modulation data signal transmitted on the data power rail 60.

In some embodiments, the controller 62 may set the VGH power rail 198 and the AVDD power rail 190 to supply different voltages based on the display brightness value. For example, the controller 62 may set each of the power rails 198, 190 to provide a first voltage for display brightness values less than the threshold value and a second voltage for display brightness values not less than the threshold value. Moreover, to supply the voltage V₀ to generate the gray level of G₀ 186 via the data power rail 60, the emission drain supply voltage may be less than V₀. Thus, in some embodiments, the emission drain supply voltage may additionally or alternatively be decreased by adjusting the ELVDD power rail 194.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. An electronic display comprising:
an active area comprising an array of pixels;
a plurality of data power rails coupled to the active area and configured to supply power to the array of pixels;
data driving circuitry coupled to the plurality of data power rails and configured to drive the array of pixels; and
a controller coupled to the data driving circuitry and comprising a processor, wherein the processor is configured to:
cause the array of pixels to emit light based on a display brightness value; and
cause a pixel of the array of pixels to emit light at a brightness of gray level 0 by dynamically adjusting a data power rail of the plurality of data power rails.

2. The electronic display of claim 1, wherein the processor is configured to cause the pixel to emit light at the brightness of gray level 0 by dynamically adjusting the data power rail based on the display brightness value.

3. The electronic display of claim 1, wherein the processor is configured to cause the pixel to emit light at the brightness of gray level 0 by dynamically adjusting the data power rail based on a refresh rate of the electronic display.

4. The electronic display of claim 1, wherein the processor is configured to cause the pixel to emit light at the brightness of gray level 0 by dynamically adjusting the data power rail based on an emission duration of the electronic display.

5. The electronic display of claim 1, comprising gate driving circuitry coupled to the active area and configured to transmit gate activation signals to activate one or more rows of pixels of the array of pixels.

6. The electronic display of claim 5, comprising a logic supply power rail coupled to the active area and the gate driving circuitry, wherein the processor is configured to decrease a high gate voltage supplied to the pixel by dynamically adjusting the logic supply power rail.

7. The electronic display of claim 6, wherein the processor is configured to decrease the high gate voltage supplied to the pixel by dynamically adjusting the logic supply power rail based on the display brightness value.

8. The electronic display of claim 5, comprising a logic supply power rail coupled to the active area and the gate driving circuitry, wherein the processor is configured to decrease an analog supply voltage supplied to the pixel by dynamically adjusting the logic supply power rail.

9. The electronic display of claim 8, wherein the processor is configured to decrease the analog supply voltage supplied to the pixel by dynamically adjusting the logic supply power rail based on the display brightness value.

10. The electronic display of claim 1, comprising power management circuitry coupled to the active area and configured to manage power in the electronic display.

11. The electronic display of claim 10, comprising an emission power rail coupled to the active area and the power management circuitry, wherein the processor is configured to decrease an emission drain supply voltage supplied to the pixel by dynamically adjusting the emission power rail.

12. A system comprising:
a voltage regulator configured to supply a maximum voltage to a pixel of an electronic display;
a resistor string coupled to the voltage regulator and comprising a plurality of resistors; and
a multiplexer coupled to the resistor string and configured to select a resulting voltage output from the resistor string after a resistance of one or more resistors of the plurality of resistors is applied to the maximum voltage, wherein the resulting voltage output generates a brightness of gray level 0 at the pixel.

13. The system of claim 12, wherein the multiplexer is configured to select the resulting voltage output based on a display brightness value of the electronic display.

14. The system of claim 12, comprising:
a plurality of resistor strings coupled to the voltage regulator, wherein the plurality of resistor strings comprises the resistor string;
a plurality of multiplexers, wherein:
the plurality of multiplexers comprises the multiplexers;
each multiplexer of the plurality of multiplexers is coupled to a respective resistor string of the plurality of resistor strings and configured to select a respective resulting voltage output from the respective resistor string; and
the respective resulting voltage outputs generate a plurality of brightnesses of different gray levels at the pixel.

15. A method comprising:
receiving, via processing circuitry, a display brightness value;
if the display brightness value is less than a threshold value, generating, via the processing circuitry, a brightness of gray level 0 by supplying a lower data voltage from a voltage regulator that is less than a maximum data voltage of the voltage regulator; and
if the display brightness value is not less than the threshold value, generating, via the processing circuitry, a brightness of gray level 0 by supplying a higher data voltage from the voltage regulator that is greater than the lower data voltage and less than the maximum data voltage of the voltage regulator.

16. The method of claim 15, comprising dynamically adjusting, via the processing circuitry, a high gate voltage.

17. The method of claim 16, wherein dynamically adjusting, via the processing circuitry, the high gate voltage comprises:
if the display brightness value is less than the threshold value, setting, via the processing circuitry, the high gate voltage to a lower high gate voltage; and
if the display brightness value is not less than the threshold value, setting, via the processing circuitry, the high gate voltage to a higher high gate voltage.

18. The method of claim 15, comprising dynamically adjusting, via the processing circuitry, an analog supply voltage.

19. The method of claim 18, wherein dynamically adjusting, via the processing circuitry, the analog supply voltage comprises:
if the display brightness value is less than the threshold value, setting, via the processing circuitry, the analog supply voltage to a lower analog supply voltage; and
if the display brightness value is not less than the threshold value, setting, via the processing circuitry, the analog supply voltage to a higher analog supply voltage.

20. The method of claim 15, comprising dynamically adjusting, via the processing circuitry, an emission supply drain voltage.
